(19) United States
(12) Patent Application Publication
(10) Pub. No.: US 2007/0279225 A1
(43) Pub. Date: Dec. 6, 2007

(54) Non-backscatter passive RFID

(76) Inventors: Stefano Pellerano, Beaverton, OR (US); Javier Alvarado, Ithaca, NY (US); Yorgos Palaskas, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/443,592

(22) Filed: May 30, 2006

(51) Int. Cl. G08B 13/14

(52) U.S. Cl. 340/572.1

(57) ABSTRACT

A radio frequency identification (RFID) system may use passive RFID tags that harvest electrical energy from a received signal and store that harvested electrical energy in a capacitor. The stored electrical energy may then be used to transmit from the RFID tag after the received signal has stopped. To decrease the size of the capacitor that is needed, the RFID tag may transmit only briefly, and then use a subsequent received signal to charge up the capacitor for another brief transmission. In some embodiments, each transmission only represents a single binary bit, but a series of such transmissions may be used to transmit multiple bits. Some embodiments may use a radio frequency of 10's of gigahertz.

### BACKGROUND

A passive radio frequency identification (RFID) tag has no self-contained power source, but rather harvests its operating power from the radio frequency (RF) signal received from the wireless device (typically called an RFID reader) that is interrogating it. Since the harvested power is usually very low (e.g., a few microwatts), passive RFID tags typically operate by simply modulating antenna impedance, so that the signal that is backscattered (i.e., reflected), from the antenna is a modulated version of the signal that was received. Since the RFID reader is receiving a very weak signal while transmitting a much stronger signal on the same frequency, high isolation between the transmitter and receiver sections is required, thus increasing the complexity and cost of the RFID reader. An additional problem with a conventional passive RFID tag is that the size of the antenna, which is dictated by the frequency being used and is typically many times larger than the rest of the RFID tag, creates a minimum size for the RFID tag that makes the tag unfeasible for many applications.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a diagram of an RFID tag, according to an embodiment of the invention.

FIG. 2 shows a schematic of a portion of an RFID tag, according to an embodiment of the invention.

FIGS. 3A and 3B show a schematic of another portion of an RFID tag, according to an embodiment of the invention.

FIG. 4 shows an RFID system, according to an embodiment of the invention.

FIG. 5 shows a flow diagram of a method performed by an RFID tag, according to an embodiment of the invention.

FIG. 6 shows a flow diagram of a method performed by an RFID reader, according to an embodiment of the invention.

FIG. 7 shows a flow diagram of a method to calibrate an RFID reader transmission parameter, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “wireless” may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

Within the context of this document, an RFID tag (sometimes referred to as an RFID transponder) may be defined as comprising an RFID antenna (to receive an incoming wireless signal that serves to activate the RFID tag, and to transmit a wireless response in the form of a radio frequency signal), and an RFID tag circuit (which may include circuitry to store an identification code for the RFID tag, circuitry to transmit that code through the RFID antenna, and a power circuit to collect received energy from the incoming wireless signal and use some of that energy to power the operations of the RFID tag circuit). Within the context of this document, an RFID reader may be a device that wirelessly transmits a signal to the RFID tag to cause the RFID tag to wirelessly transmit a response, which may be received by the RFID reader to identify the presence of the RFID tag.

As used herein, unless otherwise specified the use of the ordinal adjectives “first”, “second”, “third”, etc., to describe a common object, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

In some embodiments, electrical power harvested by an RFID tag from a received signal may be used to charge up a capacitor in the RFID tag. After the received signal stops, the stored power may be used to transmit a response back to the RFID reader, so that the RFID reader does not have to transmit and receive at the same time. In some embodiments, only a single bit may be transmitted before the RFID reader starts transmitting a signal again and the capacitor is recharged. This cycle of alternately charging and transmitting by the RFID tag may be repeated as many times as necessary until the RFID tag completes transmitting its entire response. In some embodiments the RFID tag transmits at a frequency of 10's of gigahertz (GHz). In some embodiments, a form of pulse width modulation may be used in which the duration of each separate transmission from the RFID tag indicates the value of a binary bit being conveyed by that particular transmission.

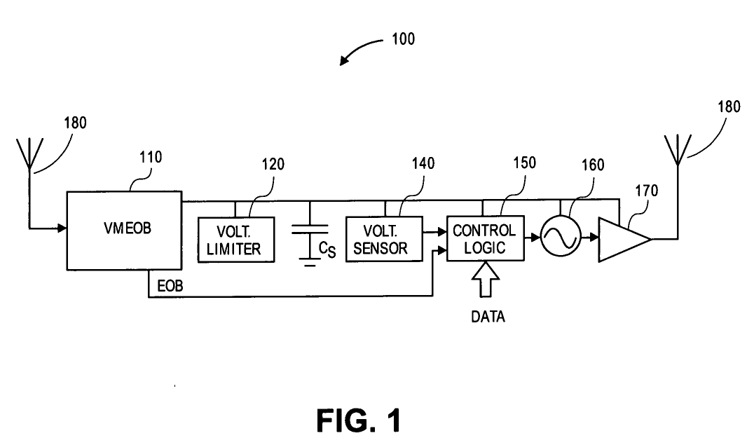

FIG. 1 shows a diagram of a an RFID tag, according to an embodiment of the invention. In the illustrated embodiment, RFID tag 100 may comprise a voltage multiplier (VM) and end-of-burst (EOB) detector 110, a voltage limiter 120, a capacitor C_{S}, a voltage sensor 140 to sense the voltage across capacitor C_{S}, control logic circuit 150, an oscillator 160, an amplifier 170, and an antenna 180. In some embodiments RFID tag 100 may receive and transmit through the same antenna 180 (shown in two parts in FIG. 1 only to indicate its connection to the receiving circuitry and to the transmitting circuitry). However, in other embodiments, separate antennas may be provided for transmitting and receiving.

When a wireless radio frequency (RF) signal is received by antenna 180, the VMEOB 110 may collect part of the electrical charge from that received signal and increase its voltage with a voltage multiplier. The increased voltage may then be used to charge up capacitor C_{S}. VMEOB 110 may also detect when the received RF signal stops, and indicate that stoppage by activating an end-of-burst (EOB) signal. The voltage limiter 120 may prevent the voltage across capacitor C_{S} from exceeding a predetermined value. The voltage limiter 120 may comprise a zener diode or other suitable circuitry to clamp the maximum voltage across C_{S} at the predetermined voltage.

Voltage sensor 140 may sense the voltage across C_{S} and trigger certain events when the voltage is at certain levels. Control logic 150 may control when the RFID tag starts and stops transmitting, based on inputs from various sources, such as control logic 150 and at least one data input. Oscillator 160 may generate a hi-frequency signal to use as a carrier wave in a transmission from the RFID tag 100. Various types of circuitry may be used, such as but not limited to a voltage controlled oscillator (VCO). The signal from oscillator 160 may be buffered and/or amplified by amplifier 170. Although called by the term ‘amplifier’ in this document, the output signal from the amplifier 170 may or may not have a higher voltage than the input signal to the amplifier 170. The output signal may be transmitted through antenna 180. The frequency of the transmitted signal may have any feasible value, such as but not limited to approximately 60 gigahertz (GHz) or approximately 24 GHz. The particular frequency used may depend on various factors, such as but not limited to 1) the associated antenna size, 2) frequency bands that are available for this application, 3) feasibility of making an RFID reader for that frequency, 4) availability of off-the-shelf RF components for that frequency, 5) etc. Using a frequency in the 10's of gigahertz permits the antenna to be very small, which may increase the number of applications that can use RFID. It also may permit a very short-duration response (such as a few nanoseconds) to be reliably transmitted, since 10's of cycles of the carrier wave will be contained in every nanosecond of transmission.

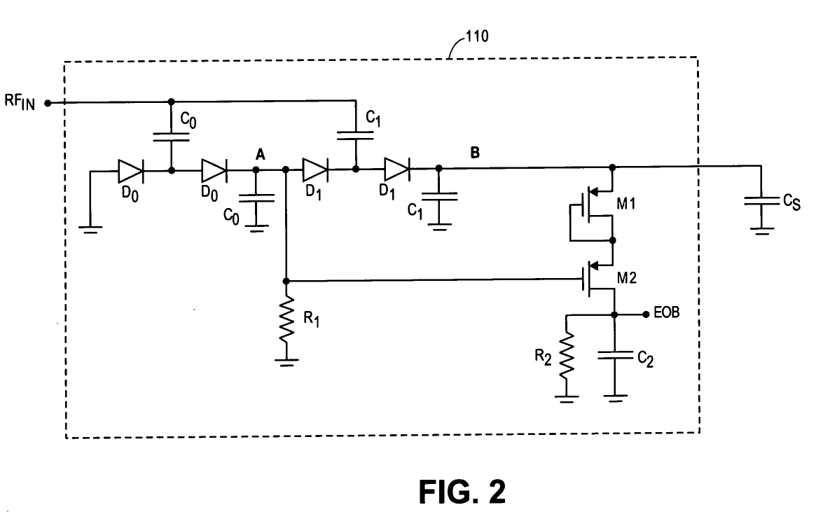

FIG. 2 shows a schematic of a portion of an RFID tag, according to an embodiment of the invention. The illustrated embodiment shows circuitry for an embodiment of VMEOB 110. As shown, the electrical energy from an incoming RF signal RF_{IN} may be rectified and multiplied by a voltage multiplier. A two stage multiplier is shown (with two diodes D₀ and two capacitors C₀ in the first stage, and two diodes D₁ and two capacitors C₁ in the second stage), but any feasible number of stages may be used to increase the accumulated charge up to the desired voltage level. Various designs for voltage multipliers are known, and each of the various components may have any feasible value. Further, the design of each stage may be different from that shown. The illustrated two stage voltage multiplier has two nodes, labeled A and B, one at the output of each respective stage. In a voltage multiplier with more than two stages, these nodes may be at any feasible location in the chain of stages. The voltage at node B may be used to charge up capacitor C_{S}. In various embodiments, the capacitance of C_{S} may be many, many times greater than that of any capacitor C₀ or C₁ in the voltage multiplier.

The end-of-burst (EOB) detector of the illustrated embodiment may use transistors M1 and M2, resistors R₁ and R₂, and capacitor C₂. As long as an RF input signal is being received, the voltage difference between node A and node B may keep transistors M1-M2 turned off, keeping the voltage at EOB near zero. But when the RF input signal stops, the capacitor at node A may discharge much faster than the capacitor at node B (which effectively is capacitor C_{S}), turning on M1-M2 and activating signal EOB. The value of R₂ may be sufficiently high to prevent C_{S} from draining through it in any significant amount when M1-M2 are turned on.

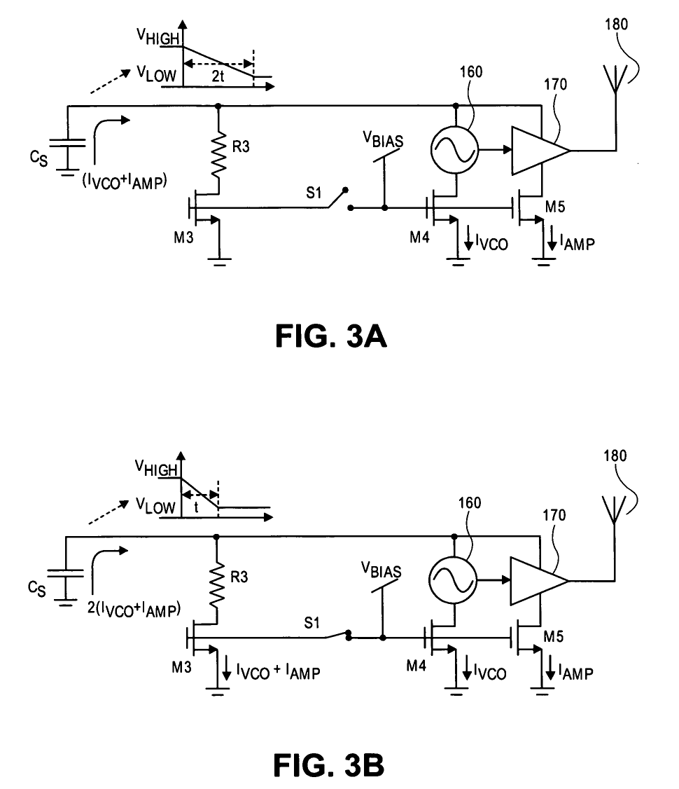

FIGS. 3A and 3B show a schematic of another portion of an RFID tag, according to an embodiment of the invention. As indicated in FIG. 3A, the activation of signal EOB may activate V_{BIAS}, thus turning on transistors M4 and M5, which then turn on oscillator 160 and amplifier 170. The hi-frequency signal output of oscillator 160 may then be transmitted through antenna 180 by amplifier 170. As long as switch S1 is open, transistor M3 may be off, and have no significant effect on the operation of the remaining circuits.

Once the RFID tag begins transmitting, the current I_{VCO} drawn by the oscillator 160 and the current I_{AMP} drawn by the amplifier 170 may begin to quickly drain capacitor C_{S}. This charge drainage may cause the voltage across C_{S} to decline from V_{HIGH} to V_{LOW}, as shown in the voltage vs. time diagram (to prevent loss of data, V_{LOW} may still be sufficiently high for digital circuitry in the RFID tag to maintain state). When the voltage reaches V_{LOW}, V_{BIAS} may be turned off, removing power from oscilllator 160 and amplifier 170 and thus stopping further transmission, as well as halting the heavy drain on capacitor C_{S}. By properly designing the circuits so that V_{HIGH}, V_{LOW}, I_{VCO}, and I_{AMP} are all known, the time to discharge from V_{HIGH} to V_{LOW} may also be known. This time has been designated in the drawing as 2t, and a transmission lasting this long may represent a particular binary value (e.g., a binary ‘1’). Feasible values for V_{HIGH} and V_{LOW} may depend on the integrated circuit technology being used (e.g., approximately 1.5 volts and 0.5 volts might be used with CMOS, but other values are also contemplated).

However, if the transmission lasts approximately only half that long (e.g., for time t), it may represent the opposite binary value (e.g., a binary ‘0’). This may be accomplished by closing switch S1 as shown in FIG. 3B, so that transistor M3 is turned on at the same time as transistors M4 and M5. Resistor R3 may have the proper value so that when M3 is turned on, the current through M3 is approximately the sum of I_{VCO} and I_{AMP}. Thus the voltage across C_{S} may only take approximately half as long to decline from V_{HIGH} to V_{LOW}, and the resulting transmission may only last for time t instead of 2t. In this manner, the duration of a given transmission from the RFID tag 100 may be used to indicate a binary ‘1’ or a binary ‘0’. Although the ratio of the two transmission times in this example is approximately 2 to 1, any suitable ratio may be used by properly sizing the ratio between the current drains with switch S1 open or closed. Switch S1 may be any feasible type of switch, such as a transistor switch.

Although most of this document describes embodiments in which two transmission time durations are used to encode two different binary values, in other embodiments additional time durations may be used to encode more that one bit at a time. For example, if the circuitry can produce transmission times with four different durations, then those four different transmission times may represent the four two-bit values of 00, 01, 10, and 11, respectively. The number of bits that may be encoded at one time may depend on the accuracy with which the duration of the transmission times can be produced in the transmitter and detected in the receiver.

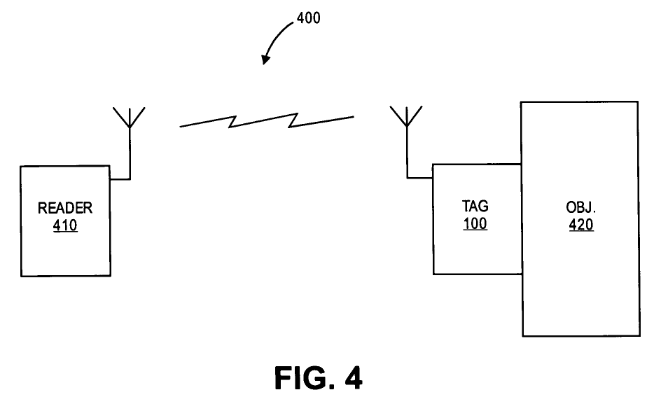

FIG. 4 shows an RFID system, according to an embodiment of the invention. In the illustrated system 400, an RFID reader 410 may activate RFID tag 100 by transmitting an RF signal of the proper frequency. RFID tag 100 may respond by transmitting its ID code and any other suitable information back to the RFID reader 410 in the manner described herein. In some embodiments, the RFID reader and RFID tag may transmit on the same frequency. The RFID reader and/or the RFID tag may use any suitable type of antenna, such as a dipole antenna, and in some embodiments may include more than one antenna. In many RFID applications, having the RFID tag identify itself to the RFID reader (by transmitting the ID code of the RFID tag) is only useful because that ID code has been associated with an object (e.g., object 420) that is connected to the RFID tag. Thus, the ID code received by the RFID reader 410 from the RFID tag 100 alerts the RFID reader 410 (or another associated computer device that communicates with the RFID reader 410) that a particular object is in the vicinity of the RFID reader 410. In various embodiments, that object may be manufactured (e.g., a box of cereal in a grocery store), a living organism (e.g., an animal with the RFID tag attached to it or implanted under its skin), environmental (e.g., a glacier moving down a mountainside), or any other feasible object.

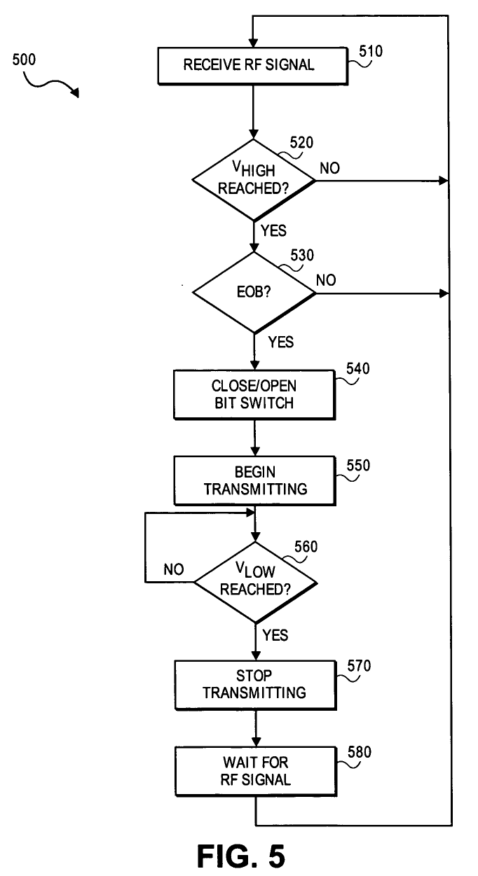

FIG. 5 shows a flow diagram of a method performed by an RFID tag, according to an embodiment of the invention. In flow diagram 500, at 510 the RFID tag may receive an RF signal of the right frequency and sufficient strength to begin charging up the RFID tag's storage capacitor. In some embodiments the RF signal may also be modulated in a way to specify which RFID tag it wishes to communicate with (such as by encoding the RF signal with the address of the RFID tag), and any other RFID tags in the area may simply refuse to respond, even though they may harvest enough power to do so. The RFID tag may continue to harvest power from the received RF signal to charge up the capacitor until the voltage across the capacitor reaches V_{HIGH}, as determined at 520. At that point, the RFID tag may wait for detection of an End-of-Burst (EOB) indication at 530, which would signify that the RF signal is no longer being received. Although not shown, after V_{HIGH} has been reached, the RFID tag may continue to harvest power from the received RF signal, but clamp the voltage across the capacitor at V_{HIGH}. When the RF signal stops, as determined by the EOB indication, the RFID tag may prepare to transmit, using the charge in its storage capacitor to power the transmission. Before transmitting, the RFID tag may close or open a switch at 540 that will determine the length of its transmission (alternately, the switch position may have been set earlier) and begin transmitting at 550. Transmission may continue until the voltage across the capacitor has declined to a second predetermined value (e.g., V_{LOW}) at 560, at which point the transmission may stop at 570. The RFID tag may then wait at 580 until it receives another RF signal at 510, and the entire cycle may be repeated. If the RFID tag does not receive another RF signal within a certain period of time, the voltage across its capacitor may discharge to such a low value that the RFID tag's circuitry cannot maintain state anymore, and the RFID tag may have to start all over when it finally does receive another RF signal.

The cycle of FIG. 5 may continue as long as the RFID tag receives additional RF signals to recharge its capacitor, and it may eventually transmit enough bits to collectively represent an entire message (a message may include the RFID tag's identification code and possibly other information as well). If the RFID tag still receives additional RF signals after transmitting the entire message, it may begin retransmitting the same message again. Alternately, in some embodiments the RFID tag may transmit its entire message a predetermined number of times (e.g., once), and may then refuse to transmit the message again even if it continues to receive additional RF signals. In still another embodiment, the final part of the message may be an End-of-Message indicator to inform the RFID reader that the message is over, so the RFID reader may stop transmitting any more RF signals directed to this RFID tag.

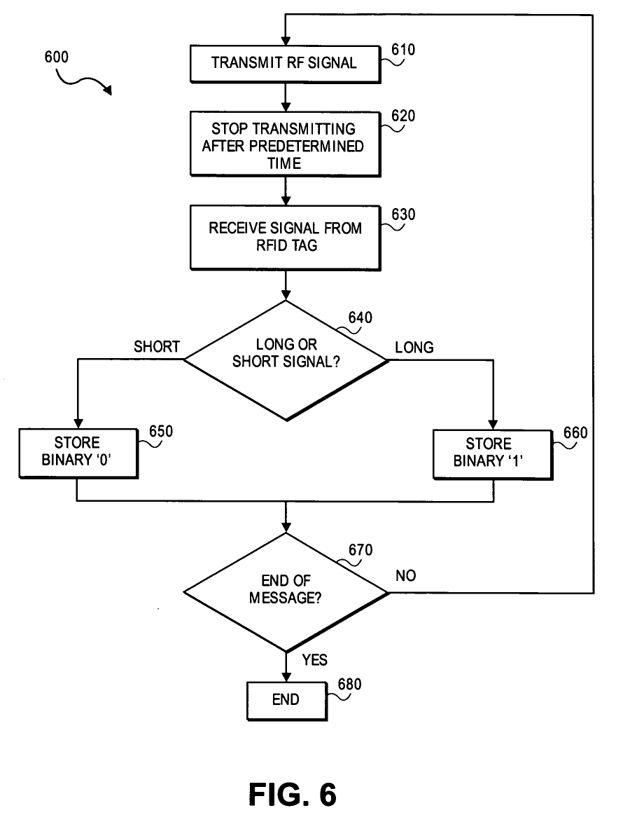

FIG. 6 shows a flow diagram of a method performed by an RFID reader, according to an embodiment of the invention. In flow diagram 600, at 610 the RFID reader may transmit an RF signal to an RFID tag, and stop transmitting at 620 after a predetermined time period. The duration of this time period may have been previously determined to be sufficient to charge up the storage capacitor in the RFID tag to a particular value (e.g., V_{HIGH}). Since the time needed for charging may vary depending on operating conditions at the time of transmission, some embodiments may use a predetermined time period intended to be sufficient for most typical operating conditions. Other embodiments may use other methods to determine the time period for transmission.

After stopping transmission at 620, the RFID reader may switch to a receive mode of operation and receive a signal from the RFID tag at 630. The duration of the signal from the RFID tag may be determined at 640 to decide what bit value was transmitted by the RFID tag. The appropriate bit value may be stored at 650 or 660. If the received bit was the last bit of a complete message, as determined at 670, the operation may end at 680. If not, the cycle may be repeated by returning to 610 to get another bit. Various means may be used to determine whether the end of the message has been received.

As previously mentioned, the RFID reader needs to transmit an RF signal to the RFID tag long enough for the storage capacitor in the RFID tag to charge up to V_{HIGH}. It may take much longer for the RFID tag's storage capacitor to charge (e.g., 1 millisecond) than it takes for the RFID tag to transmit a one-bit response (e.g., 20 nanoseconds), so the duration of the transmission from the RFID reader may have the greatest effect on the system bandwidth. However, the time it takes to charge up to VMGH may vary widely, depending on various factors such as the distance between the RFID reader and the RFID tag, the orientation of the RFID tag's antenna, the power with which the RFID reader is transmitting, etc. In some embodiments, the RFID reader may always transmit the RF signal at a fixed power for a fixed duration of time, and those two values may be sufficiently large that the combination will work in most anticipated situations. However, this approach may require time periods that are much longer than needed in most situations (which can decrease the bandwidth of the system), or that use more power than needed (which can be deterimental in a battery powered RFID reader). To address this problem, in some embodiments the RFID reader may calibrate either the duration or the transmission power of the RF signal used to charge up the capacitor in the RFID tag.

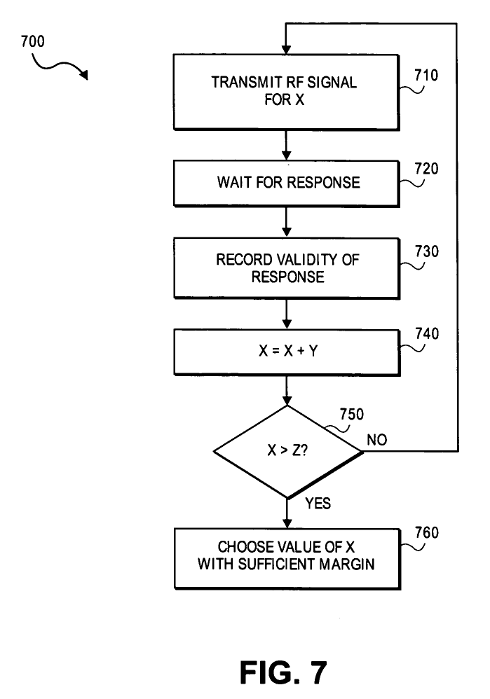

FIG. 7 shows a flow diagram of a method to calibrate an RFID reader transmission parameter, according to an embodiment of the invention. The illustrated method may be used to determine a desirable value for a transmission parameter for the RFID reader, so that the communications between the RFID reader and RFID tag will not require an undue amount of time and/or power. In flow diagram 700, the variable ‘X’ may represent the time the RF signal is transmitted from the RFID reader. Alternately, X may represent the power with which the RF signal is transmitted from the RFID reader. In some embodiments the RFID reader may perform one test with transmission time as the variable, and another test using transmission power as the variable.

The following description will use the variable X to represent the time the RFID reader transmits an RF signal to charge up the storage capacitor in the RFID tag. However, the same process may be followed using X as the transmission power of the RFID reader. At 710, the RFID reader may transmit an RF signal to the RFID tag for a time X, and wait for a response at 720. If a valid response is not received (e.g., no response is received, or the response is too weak to be reliable, or the duration of the response does not match up with a valid duration), the RFID reader may record that fact at 730 for the associated time X. Alternately, if a valid response is received, that fact may be recorded at 730 for the associated time X. The value of X may then be incremented to a higher value at 740, so that operations 710-730 may be repeated with this new value of X.

As determined at 750, operations 710-740 may be repeated until X reaches a predetermined maximum value of Z. At that point, a table may have been created for various time values of X, showing whether a valid response was received from the RFID tag for each value of X in the table. The value of X at which a valid response was first received may be considered the minimum time the RFID reader needs to transmit an RF signal to get a valid response from the RFID tag. To provide a margin of reliability, a value of X higher than this minimum may be chosen at 760 for subsequent communications.

Just as increasing the time of transmission increases the amount that the capacitor may charge up for a given transmission power, increasing the power of that transmission may decrease the time required to charge up that capacitor. The method of flow diagram 700 may therefore also be used to show a test that incrementally increases transmission power for each cycle, and finally chooses a transmission power to be used to in the subsequent communications. In some embodiments, only transmission time or transmission power may be varied, but in other embodiments both may be varied, and the test of FIG. 7 may be performed twice, once for time and once for power. Any feasible algorithm may be used to determine the proper mix of the two values that will be used.

Regardless of whether time, power, or both are being tested, various techniques may be used, either calculated and/or experimentally determined, to determine the starting value for X, the amount of the increment Y, the maximum value Z, and a reasonable margin for the final chosen value(s). Although the foregoing description starts with a small value of X and increments it to a maximum value Z, other embodiments may start with a large value of X and decrement it to a minimum value of Z. More complicated techniques (e.g., varying the amount of the increment), may also be used.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising
a radio frequency identification (RFID) tag circuit, including:
a capacitor capable of storing enough electrical charge to power the RFID tag circuit long enough for the RFID tag circuit to transmit a signal representing at least one binary bit;
a first circuit coupled to the capacitor to convert a received radio frequency signal into the electrical charge to store in the capacitor; and
a second circuit coupled to the capacitor and having an oscillator circuit to produce a carrier wave and an amplifier circuit to transmit the carrier wave through an antenna after the received radio frequency signal is no longer being received.

2. The apparatus of claim 1, wherein the first circuit comprises a voltage multiplier circuit.

3. The apparatus of claim 1, wherein the first circuit comprises an end-of-burst detection circuit.

4. The apparatus of claim 1, wherein the second circuit comprises a pulse width modulation circuit.

5. The apparatus of claim 4, wherein the pulse width modulation circuit is operable to cause the second circuit to transmit for a first time period to represent a binary ‘one’, and to transmit for a second time period, different than the first time period, to represent a binary ‘zero’.

6. The apparatus of claim 5, wherein a length of the first time period is determined by a length of time to discharge the capacitor from approximately a first voltage to approximately a second voltage.

7. The apparatus of claim 1, further comprising an object coupled to the RFID tag, the object to be associated with an identification code to be transmitted by the RFID tag.

8. The apparatus of claim 1, wherein the at least one binary bit consists of a single binary bit.

9. An apparatus, comprising
a radio frequency identification (RFID) reader device to:
transmit, and then stop transmitting, a first wireless signal for a first time period;
receive, subsequent to said stopping transmitting, a second wireless signal from an RFID tag representing at least one binary bit; and
repeating said transmitting and said receiving multiple times to receive multiple binary bits from the RFID tag.

10. The apparatus of claim 9, wherein at least some of the multiple binary bits are to collectively represent an identification code of the RFID tag.

11. The apparatus of claim 9, wherein the first wireless signal is to be encoded with an address of the RFID tag.

12. The apparatus of claim 9, wherein the first wireless signal and the second wireless signal have approximately a same radio frequency.

13. The apparatus of claim 9, further comprising a dipole antenna.

14. A method, comprising
storing, in a capacitor in a radio frequency identification (RFID) tag, electrical energy harvested from a received first radio frequency (RF) signal; and
using the stored electrical energy to transmit a second RF signal from the RFID tag when the first RF signal is no longer being received.

15. The method of claim 14, wherein a binary value represented by the second signal is indicated by a duration of the second signal.

16. The method of claim 15, wherein the binary value represented by the second signal is a binary value for a single binary bit.

17. The method of claim 14, further comprising repeating said storing and repeating said using, to transmit multiple binary bits.

18. A method, comprising:
transmitting a first wireless signal to a radio frequency identification (RFID) tag for a first time period;
receiving, subsequent to said first time period, a second wireless signal from the RFID tag; the second wireless signal representing at least one binary bit; and
repeating said transmitting and said receiving a plurality of times to receive a plurality of wireless signals collectively representing a plurality of binary bits.

19. The method of claim 18, wherein the plurality of binary bits includes an identification code for the RFID tag.

20. The method of claim 18, wherein the second wireless signal includes pulse width modulation to encode the at least one binary bit.

21. An article comprising
a tangible machine-readable medium that contains instructions, which when executed by one or more processors result in performing operations comprising:
transmitting a first wireless signal to a radio frequency identification (RFID) tag for a first time period;
receiving, subsequent to said first time period, a second wireless signal from the RFID tag; the second wireless signal representing at least one binary bit; and
repeating said transmitting and said receiving a plurality of times to receive a plurality of wireless signals collectively representing a plurality of binary bits.

22. The article of claim 21, wherein the operation of repeating said receiving includes receiving an identification code for the RFID tag.

23. The article of claim 21, wherein the operation of said receiving includes receiving a second wireless signal incorporating pulse width modulation to encode the at least one binary bit.

24. The article of claim 21, wherein the operations further comprise calibrating a parameter before said transmitting the first wireless signal, said calibrating comprising the operations of:
transmitting a test signal to the RFID tag at a particular power level for a particular duration of time;
storing information indicating if a valid response was received from the RFID tag in response to said transmitting the test signal;
changing at least one of the particular power level and the particular duration of time;
repeating said transmitting a test signal, said storing information, and said changing, multiple times to produce multiple entries of the information; and
choosing at least one of the entries as a parameter to be used in further communications with the RFID tag.
